(19) United States
(12) Patent Application Publication
(10) Pub. No.: US 2009/0000469 A1
(43) Pub. Date: Jan. 1, 2009

(54) Piston-cylinder unit

(75) Inventors: Klaus Schmitz, Eitorf (DE); Hubert Beck, Eitorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: ZF Friedrichshafen AG, Friedrichshafen (DE)

(21) Appl. No.: 12/214,953

(22) Filed: Jun. 24, 2008

(30) Foreign Application Priority Data
Jun. 26, 2007 (DE) 10 2007 029 490.7

(51) Int. Cl. F16J 3/06

(52) U.S. Cl. 92/99

(57) ABSTRACT

A piston-cylinder unit configured to provide a level adjustment function based on internal pressure includes a working cylinder, a piston rod, a working piston mounted on the piston rod, and fastening elements coupled to the piston rod and the working cylinder. Each fastening element is configured to attach to a chassis or a vehicle body. One of the fastening elements is mountable with freedom of axial movement relative to the piston rod or the working cylinder and includes a cylindrical bore and a chamber disposed between the cylindrical bore and an end surface of the piston rod or a journal of the working cylinder. The end surface of the piston rod or the journal includes a first effective pressure-actuated cross-sectional area approximately the same as a second effective pressure-actuated cross-sectional area of the piston rod. The first and the second cross-sectional areas are actuated by system pressure.

### BACKGROUND OF THE INVENTION

1. Field of the Invention

The invention relates generally piston-cylinders, and more particularly to a piston-cylinder unit that includes a fastening element that easily supports any extra weight loaded onto the vehicle and simultaneously isolates the vehicle body from high-frequency, short-stroke road excitations without any significant reduction in the damping effect at longer strokes.

2. Description of the Related Art

Piston-cylinder units are known, for example, from U.S. Pat. No. 6,202,993 and GB 2 144 584, where the piston rod of a piston-cylinder unit is attached to the vehicle body by way of a bearing. These bearings have elastic rubber elements to absorb vibrations. When bearing eyes are used, elastic rubber elements are also usually inserted between the eye and the vehicle body. These fastening devices suffer from the disadvantage that they produce an uncomfortable sensation when subjected to high-frequency excitation by the road surface, especially at small amplitudes. One of the reasons for this is that the rubber fastening parts of the vibration damper at the vehicle body or at the wheel suspension become hard and thus transmit vibrations and noise into the passenger compartment. In addition, because of the high natural frequency and the short-stroke movement of the piston, the alternating action of the damping and check valves of the damping piston becomes progressively worse, so that again an uncomfortable stiffening of the piston-cylinder unit is present.

There are also piston-cylinder units however, for example, from DE 10 2004 061 997, which consist of a working cylinder, in which a working piston mounted on a piston rod is installed with freedom of axial movement, where the piston rod and the working cylinder have fastening elements by which they are attached to the chassis and to the body of a vehicle, where at least one of the fastening elements is mounted with freedom of axial movement relative to the piston rod and/or the working cylinder.

### SUMMARY OF THE INVENTION

An object of the invention is to design a piston-cylinder unit in such a way that the fastening element easily supports any extra weight loaded onto the vehicle and simultaneously isolates the vehicle body from high-frequency, short-stroke road excitations without any significant reduction in the damping effect at longer strokes, and so that not only does the onset of the damping occur gently but also so that abrupt discontinuities in the production of the damping force are avoided.

This object is accomplished according to the invention in that the piston-cylinder unit is provided with a level adjustment function acting on the basis of internal pressure, and the end surface of the piston rod located in the chamber or the end surface of the journal located in the chamber has a first effective pressure-actuated cross-sectional area which is approximately the same as the second effective pressure-actuated cross-sectional area of the piston rod inside the piston-cylinder unit, where the first and the second cross-sectional areas are actuated by the system pressure.

The advantage of the invention is that the fastening elements, when used as level-control elements, can satisfactorily support the vehicle body as well as any extra weight loaded onto the vehicle, but at the same time an optimum of driving comfort and noise isolation in the vehicle is present in the high-frequency, small-amplitude range of the excitations caused by the road surface. When the piston-cylinder unit is excited at high frequency with small amplitudes, most of the force is absorbed by the fastening element, at least one of which is provided, in that relative axial movement takes place between the fastening element and the piston rod or a fastening element on the working cylinder or on the container tube. When the excitations are no longer in the short-stroke, usually high-frequency range, that is, if the excitation is now of the low-frequency, large-amplitude type, the fastening element arrives in its end position with respect to its adjacent component, namely, the piston rod or the working cylinder, and then the pressure required to produce the damping force can be built up at the damping valves of the piston. In this way, both discontinuities in the damping force and noise, which is transmitted to the body of the vehicle, are avoided, and thus driving comfort can be increased.

According to another feature, the effective pressure-actuated end surface of the piston rod or the effective pressure-actuated end surface of the journal and the effective pressure-actuated cross-sectional area of the piston rod inside the piston-cylinder unit are all of equal size. The advantage here is that the pressure-equalized piston rod is isolated from the fastening bearing, and the elastic piston rod connection is not called upon to provide any bearing force at all. The bearing force is generated exclusively by the damping medium in the hollow piston rod, which is under the system pressure, where the pressure of the damping medium acts on the area of the bottom region of the chamber, which is of the same size as the cross-sectional area of the piston rod.

According to still another feature, the effective pressure-actuated end surface of the piston rod or the effective pressure-actuated end surface of the journal and the effective pressure-actuated cross-sectional area of the piston rod inside the piston-cylinder unit are of different sizes, depending on the required pretension of the piston rod in the inward-travel or outward-travel direction of the piston rod.

According to one embodiment, at least one elastic element is provided as a stop between the fastening element and the piston rod and/or the working cylinder.

According to another embodiment, a chamber, serving a damping purpose, is formed between the cylindrical bore and the end surface of the piston rod and/or the journal. It is advantageous here for the chamber to be filled with the incompressible medium present in the piston-cylinder unit and for the chamber to be connected to one of the working spaces of the working cylinder by a flow connection.

According to still another embodiment, the chamber is sealed off against the atmosphere by a seal.

According to yet another feature, when the piston-cylinder is used as part of a hydropneumatic spring, the chamber is connected to the working space provided with high-pressure by the flow connection.

It is also provided that the flow connection and/or the opening are designed as a throttle to produce the damping force and/or a damping valve is assigned to the flow connection.

According to still another embodiment, at least one of the fastening elements is designed as a rubber-metal part.

It is also provided that the spring stiffness of the force-transmitting rubber-metal part of the fastening element is greater than that of the elastic element. It can also be provided that the force-transmitting rubber-metal part of the fastening element and the elastic element are assembled to form a single component.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred exemplary embodiments of the invention are illustrated schematically in the figures.

FIG. 1 is an illustrative cross-sectional diagram of a piston-cylinder unit with an integrated vehicle level control function, according to one embodiment of the invention.

FIG. 2 is an illustrative cross-sectional diagram of a piston-cylinder unit designed as a spring cylinder, where the damping medium is introduced into the piston-cylinder unit from the outside, according to one embodiment of the invention.

FIG. 3 is an illustrative cross-sectional diagram of a fastening element, in isolation, mounted on the piston rod side, according to one embodiment of the invention.

FIGS. 4, 5, and 6 are illustrative cross-sectional diagrams of the fastening element of FIG. 3 under different loads.

FIGS. 7 and 8 are illustrative cross-sectional diagrams of a fastening element, which can be connected to or disconnected from the piston rod of the piston-cylinder unit, according to one embodiment of the invention.

FIG. 9 is an illustrative cross-sectional diagram of a fastening element including an elastic piston rod connection and a rubber-metal part, according to one embodiment of the invention.

### DETAILED DESCRIPTION OF THE PRESENTLY PREFERRED EMBODIMENTS

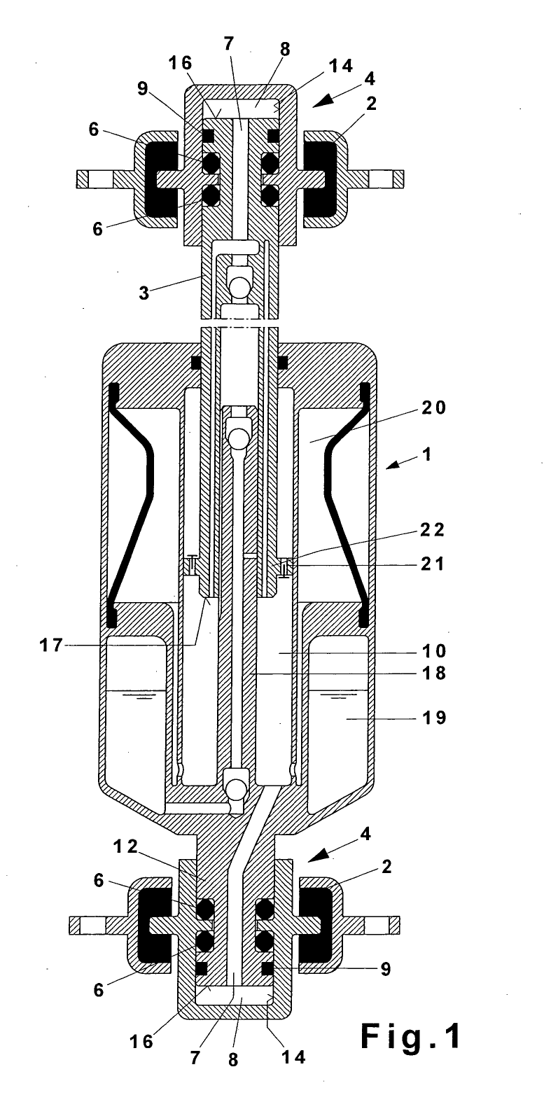

A piston rod 3 of a piston-cylinder unit 1 shown in FIG. 1 includes a fastening element 4 that includes a rubber-metal part 2 so that it can be fastened to the body of a vehicle. As shown in the lower area, the cylinder of the piston-cylinder unit 1 also includes a fastening element 4 that includes another rubber-metal part 2 so that it can be connected to the axle of the motor vehicle.

Through the design of the piston-cylinder unit 1 as a hydropneumatic level control device, the piston rod 3 is brought to a predetermined level by the internal pressure of the unit as a function of load.

Each upper fastening element 4 in FIG. 1 defines a cylindrical bore 14 in which the piston rod 3 is received. The fastening element 4 is connected to the piston rod 3, in that the piston rod 3 cooperates with a radial projection of the fastening element 4 by way of elastic elements 6. The lower fastening element 4 is similarly connected to a journal 12 of the cylinder.

The fastening element 4 consists overall of a two elastic sections, namely, the force-transmitting elastic area, i.e., the rubber-metal part 2, and the elastic piston rod connection 6. So that the two elastic areas 2 and 6 can work independently of each other, the system pressure of the level control element is conducted to a chamber 8 via a flow connection 7. The chamber is sealed off against the atmosphere by a seal 9. The piston rod 3, which is now pressure-equalized, is isolated from the fastening element 4, and the elastic piston rod connection 6 thus is not called upon to absorb any bearing force at all.

The bearing force is provided exclusively by the damping medium of the hollow piston rod 3, which is under the system pressure. The pressure of the damping medium acts effectively on a surface area 16 of the bottom of the chamber 8, which is of the same size as the cross-sectional area 17 of the piston rod.

The level control element works by way of the hollow piston rod 3 and the corresponding pump rod 18, where, by way of an appropriate number of check valves, damping medium is conveyed from the low-pressure chamber 19 to the high-pressure chamber 20. The damping valves 21 in the damping piston 22 serve to provide the actual damping of the piston-cylinder unit 1.

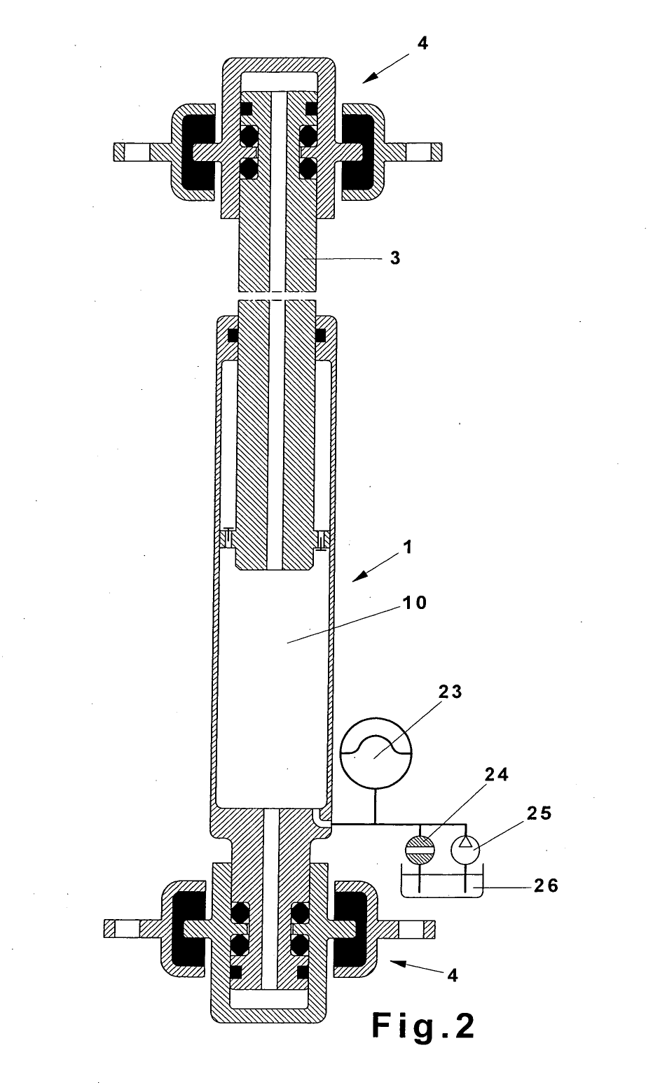

FIG. 2 shows another embodiment of a piston-cylinder unit 1, in which the fastening elements 4 are the same in principle as those of FIG. 1. Because what is involved here is a spring cylinder, the working space 10 is supplied with damping medium from a reservoir 26 by way of a pressure accumulator 23, a shut-off valve 24, and a pump 25. Otherwise, the connection of the piston rod 3 is the same as that in the embodiment shown in FIG. 1.

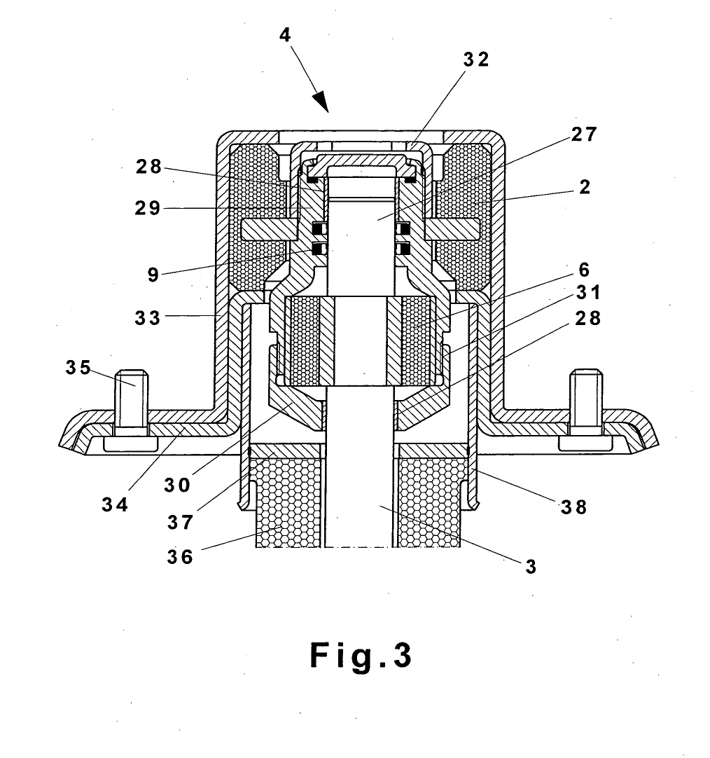

FIG. 3 shows, in isolation, a fastening element 4, where, at the end of the piston rod 3, an elastic piston rod connection 6 is provided in the form of a fastening part 27, which can be screwed into the piston rod 3. For the purpose of equalizing the pressure, the fastening part 27 has a diameter in the area of a seal 9, which is the same as that of the piston rod 3. In this exemplary embodiment, the elastic piston rod connection 6 consists of an inner sleeve and an outer sleeve, between which a rubber part is disposed, and which is vulcanized in place. In addition, an upper housing 29, equipped with a guide 28 and the seal 9, and a lower housing 30 with a guide 28 are provided. The outer and inner sleeves of the elastic piston connection 6 are clamped together by the threaded joint between the housing parts 29, 30. The force-transmitting elastic area 2 in the form of a rubber-metal part is connected to the upper housing 29 by a coupling nut 32.

When the fastening element 4 is attached to the body of the vehicle, the force-transmitting elastic area 2 is put under axial pretension on one side by the outer bearing housing 33 and on the other side by the inner bearing housing 34. The fastening screws 35 connect the fastening element 4 to the vehicle body. A bump stop 36, which limits the inward travel of the piston rod 3, rests on a disk 37 and is connected to the inner bearing housing 34 by a tubular section 38. The inner bearing housing 34 serves on one side to arrest the rubber-metal part 2, and on the other side it absorbs forces introduced via the bump stop 36.

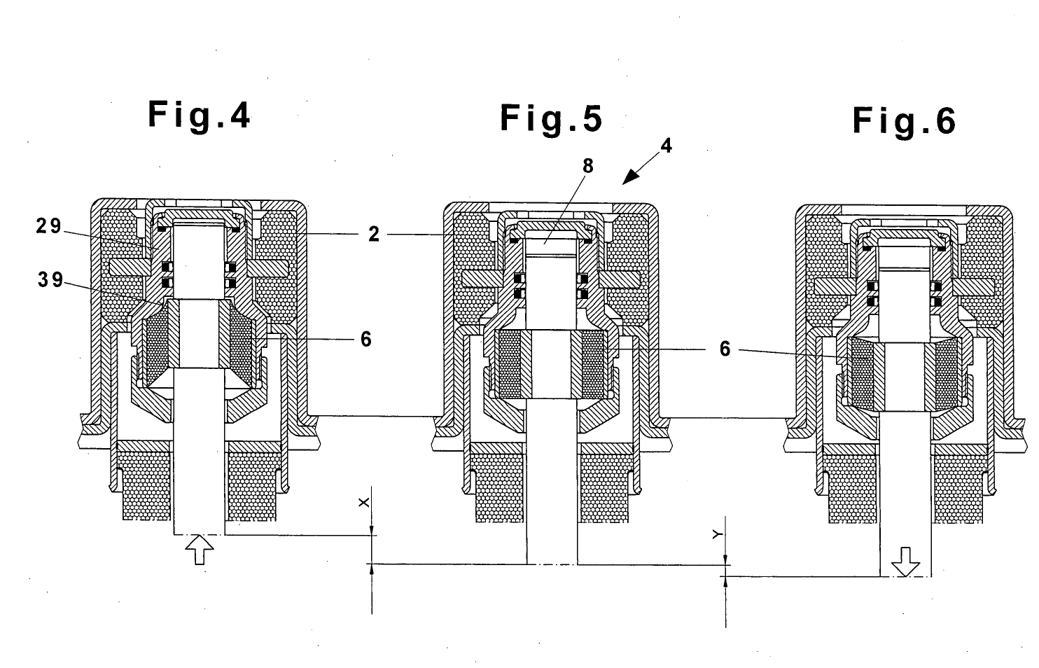

The fastening element 4 shown in FIG. 3 is illustrated under various loads in FIGS. 4-6.

FIG. 5 shows the fastening bearing 4 in the rest state. The pressure equalization achieved by the pressure-equalization chamber 8 means that no bearing force acts on the elastic piston rod connection 6. The bearing force is transmitted exclusively by way of the force-transmitting elastic area of the rubber-metal part 2.

FIG. 4 shows the maximum inward-travel distance X of the piston, which is absorbed for the most part by the elastic piston rod connection 6. A small part is absorbed by the force-transmitting elastic area of the rubber-metal element 2. The elastic piston rod connection 6 is not as stiff as the force-transmitting elastic area of the rubber-metal element 2. So that the spring stiffness of the elastic piston rod connection 6 can proceed progressively in the desired way, a roll-down contour 39 is provided for the rubber area in the upper housing 29.

FIG. 6 shows the maximum outward-travel distance Y of the piston, proceeding from the central position shown in FIG. 5. For reasons of driving comfort, this distance is preferably shorter than the maximum inward-travel distance X. The high-frequency excitation proceeding from the road surface is to be absorbed over a long distance in the compression stage of the piston-cylinder unit according to FIG. 4 and absorbed over a short distance in the tension stage according to FIG. 6. The elastic piston rod connection 6 always moves more easily than the damping force allows the damping piston to move, which means that the elastic piston rod connection 6 will start to move even before the damping piston moves axially in its working cylinder.

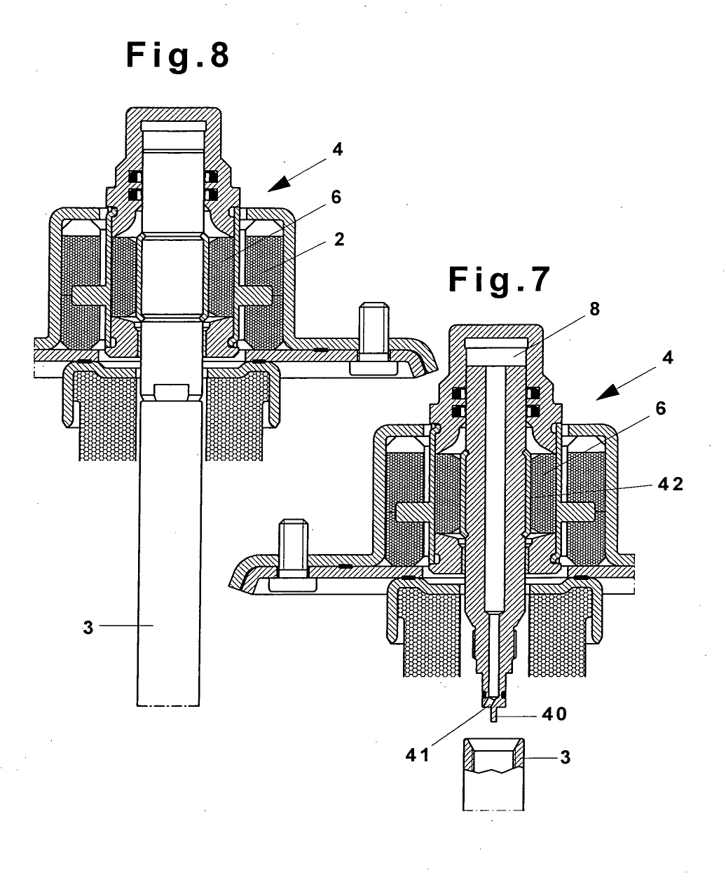

FIGS. 7 and 8 show an exemplary embodiment in which the fastening element 4 can be detached from the piston rod 3. Here, according to FIG. 7, a check valve is installed in the hollow piston rod. Upon installation of the fastening element 4, this valve can be opened by the pin 40, so that a flow connection is established via the opening 41 between the working space 10 of the piston-cylinder unit 1 and the chamber 8.

When the fastening element 4 is detached from the piston rod 3 again, the pin 40 moves away from a corresponding check valve located in the hollow piston rod 3.

This other check valve thus closes off the flow connection, and the fastening element 4 can be removed.

FIG. 8 shows the installed unit consisting of the fastening element 4 and the hollow piston rod 3.

In FIGS. 7 and 8, the elastic area of the rubber-metal part 2 is located radially outside the piston rod 3, and the elastic piston rod connection 6 in these exemplary embodiments is designed as a cylindrical rubber part, held on the piston rod by a bushing 42. The elastic piston rod connection 6 in this exemplary embodiment is vulcanized both radially on the inside to the bushing 42 and attached radially on the outside to another bushing, by, e.g., vulcanization.

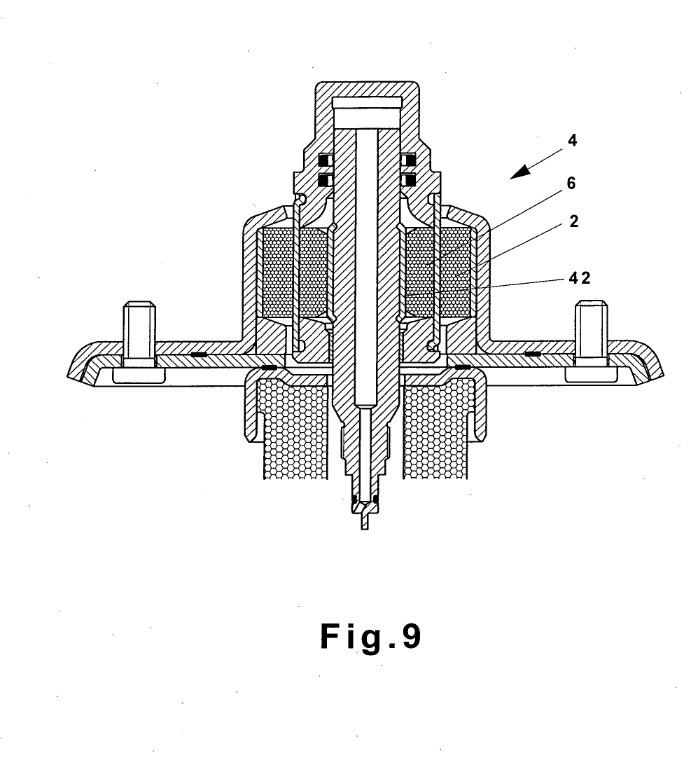

FIG. 9 shows an exemplary embodiment essentially similar to that of FIG. 7, where the fastening element 4 has an elastic piston rod connection 6 and a rubber-metal part 2. The fastening element thus consists of at least two rubber-elastic parts and at least three corresponding bushings 42. Here the elastic piston rod connection 6 and the rubber-metal part 2 are connected to each other appropriately by vulcanization.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A piston-cylinder unit configured to provide a level adjustment function based on internal pressure, comprising:
a working cylinder having a working space filled with an incompressible medium;
a working piston mounted on a piston rod and disposed in the working cylinder freedom of axial movement, the piston dividing the working space into two working chambers;
a first fastening element coupled to the piston rod and a second fastening element coupled to the working cylinder, each of said first and second fastening elements being configured for attachment to a chassis or a body of a vehicle, at least one of the first fastening element being mountable with freedom of axial movement relative to the piston rod or the second fastening element being mountable with freedom of axial movement relative to the working cylinder, said at least one of the first and second fastening elements comprising:
a cylindrical bore in which a terminal area of one of the piston rod or a journal connected to the working cylinder is held with freedom of axial movement, and
a chamber disposed between the cylindrical bore and an end surface of the terminal area of the one of the piston rod or the journal, the end surface comprising a first effective pressure-actuated cross-sectional area approximately the same as a second effective pressure-actuated cross-sectional area of the piston rod, the first and the second cross-sectional areas being actuated by system pressure.

2. The piston-cylinder unit according to claim 1, wherein the effective pressure-actuated end surface of the terminal area of the one of the piston rod or the journal and the effective pressure-actuated cross-sectional area of the piston rod inside the piston-cylinder unit are all of the same size.

3. The piston-cylinder unit according to claim 1, wherein the effective pressure-actuated end surface of the terminal the of the piston rod or the journal and the effective pressure-actuated cross-sectional area of the piston rod inside the piston-cylinder unit are different sizes to effect a required pretension of the piston rod in the inward-travel or outward-travel direction of the piston rod.

4. The piston-cylinder unit according to claim 1, further comprising a stop including at least one elastic element between the fastening element and the at least one of the piston rod and the journal.

5. The piston-cylinder unit according to claim 1, wherein the chamber is configured to provide damping between the cylindrical bore and the end surface of the terminal end of the at least one of the piston rod or the journal.

6. The piston-cylinder unit according to claim 1, wherein the chamber is filled with the incompressible medium present in the piston-cylinder unit.

7. The piston-cylinder unit according to claim 1, wherein the chamber is connected to one of the working chambers of the working cylinder by a flow connection.

8. The piston-cylinder unit according to claim 1, wherein the chamber is sealed from the atmosphere by a seal.

9. The piston-cylinder unit according to claim 1, wherein the piston/cylinder unit further defines a high-pressure working space, the chamber being connected by a flow connection to the high-pressure working space.

10. The piston-cylinder unit according to claim 7, wherein the flow connection is configured as a throttle to generate a damping force.

11. The piston-cylinder unit according to claim 7, wherein a damping element is assigned to the flow connection.

12. The piston-cylinder unit according to claim 1, wherein at least one of the fastening elements comprises a force-transmitting rubber-metal part.

13. The piston-cylinder unit according to claim 12, further comprising a stop including at least one elastic element disposed between the fastening element and the at least one of the piston rod and the journal, wherein a spring stiffness of the force-transmitting rubber-metal part of the fastening element is greater than a spring stiffness of the at least one elastic element.

14. The piston-cylinder according to claim 12, further comprising a stop including at least one elastic element disposed between the fastening element and the at least one of the piston rod and the journal, wherein the force-transmitting rubber-metal part of the fastening element and the at least one elastic element are assembled to form a single component.
